(19) United States
(12) Patent Application Publication
(10) Pub. No.: US 2006/0273494 A1
(43) Pub. Date: Dec. 7, 2006

(54) INJECTION MOLDING PROCESS FOR FABRICATING IN-MOLD DECORATION

(76) Inventors: Lu-Chin Wu, Taipei County (TW); Chuan-Shien Yu, Taipei City (TW); Dean-Kuo Liu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,986

(22) Filed: Jun. 3, 2005

(51) Int. Cl. B29C 45/14

(52) U.S. Cl. 264/447; 264/132; 264/259

(57) ABSTRACT

An injection molding process for fabricating an in-mold decoration is provided. The process includes the following steps. First, a plastic substrate is provided. Then, an ink pattern is formed on the plastic substrate. A pre-forming process is carried out on the plastic substrate. A trimming process is performed to cut the plastic substrate into a plurality of fashioned units. A resin injection process is performed to coat a plastic layer over the ink pattern on each fashioned unit. A hardening layer is formed over each fashioned unit to cover the surface of each fashioned unit, which is far away from the ink pattern.

### BACKGROUND OF THE INVENTION

1. Field of the Invention

The present invention relates to an injection molding process. More particularly, the present invention relates to an injection molding process for fabricating an in-mold decoration (IMD).

2. Description of the Related Art

The conventional technique of fabricating an in-mold decoration (IMD) is actually a combination of various processing techniques including ink printing, pre-forming, trimming and resin injection. These processes are often combined with different types of thin film materials, each having a particular property. Through the auxiliary processing by various types of pre-forming, trimming and resin injection molding tools, body casing components suitable for computers, consumer electronic products, information appliances or car decorative items can be produced.

In general, those products fabricated using the in-mold decoration injection technique has a transparent plastic film thereon for protecting the underlying printed ink pattern and preventing the ink pattern from any scratches so that the ink pattern can last for a long time. Thus, the conventional method of direct spray-painting, transfer printing, water-based printing, gold ironing or multi-color/multi-material injection on an object has been gradually replaced by the in-mold decoration injection molding technique.

Although the plastic film can protect the ink and the ink pattern against peeling off or fading, minor scratches on the plastic film will be evident if the plastic film covers a product having a shiny surface or having a transparent window. In other words, the plastic film is not hard enough to provide a long-time-lasting transparency for these types of products.

### SUMMARY OF THE INVENTION

Accordingly, at least one objective of the present invention is to provide an injection molding process for fabricating an in-mold decoration (IMD) capable of protecting the surface of a product against scratches.

To achieve this and other advantages and in accordance with the purpose of the invention, as embodied and broadly described herein, the invention provides an injection molding process for fabricating an in-mold decoration (IMD). First, a plastic substrate is provided. Then, an ink pattern is formed on the plastic substrate. A pre-forming process is carried out on the plastic substrate. Next, a trimming process is performed to cut the plastic substrate into a plurality of fashioned units. A resin injection process is performed to coat a plastic layer over the ink pattern on each fashioned unit. A hardening layer is formed over each fashioned unit to cover the surface of each fashioned unit, which is far away from the ink pattern.

According to one embodiment of the present invention, the method of forming the hardening layer includes performing a chemical vapor deposition (CVD) process or a physical vapor deposition (PVD) process. In addition, the physical vapor deposition process can be an evaporation process, a sputtering process or an ion plating process.

According to one embodiment of the present invention, the hardening layer can be a transparent metallic oxide or a transparent semiconductor oxide layer. In addition, the transparent metallic oxide layer can be a silicon oxide layer or an aluminum oxide layer.

According to one embodiment of the present invention, the method of forming the hardening layer includes immersing the fashioned units in a chemical solution and then performing a curing operation on the fashioned units to form the hardening layer.

According to one embodiment of the present invention, the curing process can be carried out using infrared light, ultraviolet light or heat inside a baking oven.

According to one embodiment of the present invention, the aforementioned chemical solution includes acrylates and its derivatives.

According to one embodiment of the present invention, the pencil hardness of the hardening layer is between 1 H to 7 H.

According to one embodiment of the present invention, the thickness of the hardening layer is between 10 nanometers to 1 micrometer.

According to one embodiment of the present invention, the plastic substrate can be fabricated using a material selected from a group consisting of polycarbonate (PC), polyethylene teraphthalate (PET), nylon, polymethyl methacrylate (PMMA) and acrylonitril butadiene styrene (ABS).

According to one embodiment of the present invention, the method of pre-forming the plastic substrate may be a punching process or a vacuum-forming process.

According to one embodiment of the present invention, the method of forming the ink pattern on the plastic substrate may be a screen printing operation.

According to one embodiment of the present invention, each fashioned unit comprises a plurality of protrusions and a recess or planar portion between the protrusions. In addition, every pair of adjacent protrusions may be linked to form an outer frame and the area within the surrounding outer frame is a transparent window. Furthermore, the trimming process may include cutting off the connection between two neighboring outer frames so that each fashioned unit becomes a window frame.

According to one embodiment of the present invention, after the trimming process, each fashioned unit has a plurality of protrusions and a planar portion between the protrusions.

In the present invention, a hardening layer is formed over the surface of the plastic substrate far away from the ink pattern after the injection process. Therefore, the surface of the manufactured product is less vulnerable to scratches.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1D are schematic cross-sectional views showing the mold injection process for forming an in-mold decoration according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

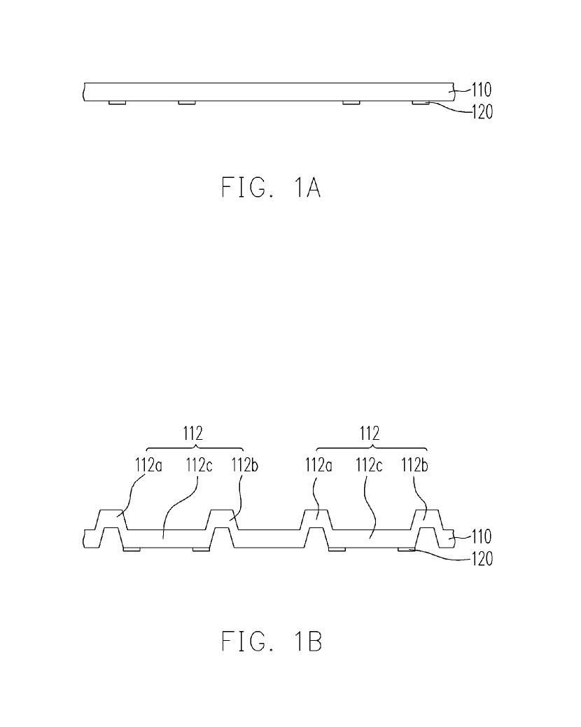

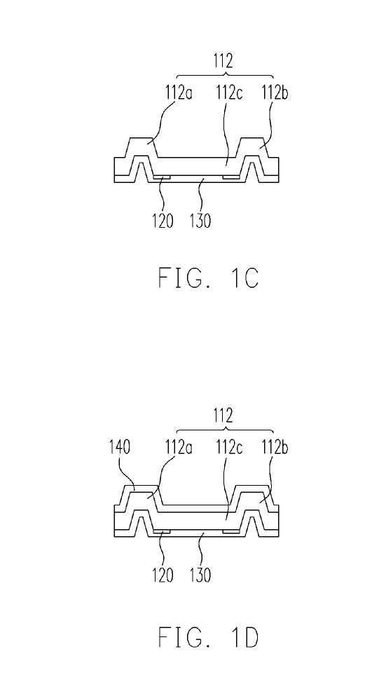

FIGS. 1A through 1D are schematic cross-sectional views showing the mold injection process for forming an in-mold decoration according to one preferred embodiment of the present invention. As shown in FIG. 1A, the injection molding process for forming the in-mold decoration includes the following steps. First, a plastic substrate 110 is provided. The plastic substrate 110 can be a transparent film having a thickness of several hundred micrometers. In addition, the plastic substrate 110 can be fabricated using PC, PET, nylon, PMMA, ABS or other thermoplastic polymers or esters. However, the plastic substrate 110 can be fabricated using PC and PET. Then, an ink pattern 120 is formed over the plastic substrate 110. The ink pattern 120 is formed by a screen printing process, a transfer printing process or other processes, for example.

As shown in FIG. 1B, a pre-forming process is carried out to shape the plastic substrate 110. Typically, the pre-forming process is a punch-forming, vacuum-forming or other pre-forming operation that produces a plurality of protrusions 112a, 112b and a planar portion 112c between the protrusions 112a, 112b on the plastic substrate 110. Furthermore, the plastic substrate 110 can have other shapes after the pre-forming operation.

As shown in FIG. 1C, the plastic substrate 110 is trimmed to form a plurality of fashioned units 112. For example, if the fashioned units 112 are window frames, each fashioned unit 112 has a plurality of protrusions 112a, 112b and a planar portion 112c between the protrusions 112a, 112b. The two protrusions 112a, 112b are connected to surround the central planar portion 112c. Furthermore, the planar portion 112c can be a transparent window. This type of fashioned units 112 can be applied to the surface of liquid crystal panel, touch-control panel or structure for protecting a lens. However, the fashioned unit 112 is not limited to the structure comprising the protrusions 112a, 112b and the planar portion 112c only.

Then, a plastic injection process is carried out on the fashioned units 112 to form a plastic layer 130 over the ink pattern 120. Typically, each fashioned unit 112 is sent into an injection mold (not shown) to form the plastic layer 130 over the ink pattern 120. After proper curing process, the plastic layer 130 protects the ink pattern 120 against possible scratches and enhancing the impact strength and anti-corrosion properties of the product. Obviously, a highly transparent material such as plastic or polymer is preferably selected for forming the plastic layer 130.

As shown in FIG. 1D, a hardening layer 140 is formed over each fashioned unit 112 to cover the surface of each fashioned unit 112, which is far away from the ink pattern 120. In other words, the hardening layer 140 covers the exposed surface of the fashioned units 112. Through the hardening layer 140 and the plastic layer 130, scratches are prevented from the fashioned units 112. In detail, the hardening layer 140 has a pencil hardness that ranges between 1 H to 7 H. According to Motorola's testing specification for structural components, the testing is carried out using Mitsubishi “UNI” series of pencil with a hardness rating from 7 B to 7 H. When an object is subjected to a hardness test, the pencil having a weight of 500 grams and tilted at an angle of 45° needs to produce a pencil line of 6.5 mm. After running the pencil across the surface of the object, the surface is inspected for scratches to determine the pencil hardness of the object. For example, when a 6 H pencil makes a scratch mark on the surface of the object while a 5 H pencil produces no scratch mark on the same surface, the pencil hardness of the object is defined to be 6 H. The hardening layer 140 can have a thickness between 10 nanometers to 1 micrometer. In addition, the hardening layer 140 can be fabricated using a transparent metallic oxide, a transparent semiconductor oxide or a transparent high molecular weigh material.

If the hardening layer 140 is fabricated using transparent metallic oxide or transparent semiconductor oxide material, it is formed by performing a chemical vapor deposition process or a physical vapor deposition process. The physical vapor deposition process includes an evaporation process, a sputtering process or an ion film-plating process. In addition, the transparent metallic oxide can be silicon oxide or aluminum oxide.

If the hardening layer 140 is fabricated using transparent high molecular weight material, it is formed by putting the fashioned units 112 in a chemical solution. Then, a curing process is carried out on the fashioned units 112 to form the hardening layer 140. In other words, the method of forming the hardening layer 140 includes a dipping process. Thus, the hardening layer 140 is not limited to just one surface of each fashioned unit 112. The hardening layer 140 may enclose the entire fashioned unit 112.

The curing process can be carried out using infrared light, ultraviolet light or heat provided by a baking oven. Furthermore, the main constituents of the chemical solution can be acrylate and its derivatives; for example, polyester acrylates, epoxy acrylates, polyurethane acrylates, silicone acrylates or multi-functional acrylate monomers such as trimethylolpropane triacrylate (TMPTA), tripropyleneglycol diacrylate (TPGDA), hexanediol diacrylate (HDDA), pentaerytrithol triacrylate (PETA) and so on.

In summary, major advantages of the injection molding process in the present invention for forming the in-mold decoration includes as follows.

1. The hardening layer that covers the surface of the product protects the product against scratches.

2. The hardening layer is formed after the completion of the product fabrication. Hence, the hardening layer is less likely to form cracks or be damaged.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An injection molding process for fabricating an in-mold decoration, comprising the steps of:
providing a plastic substrate and forming an ink pattern on the plastic substrate;
pre-forming the plastic substrate;
trimming the plastic substrate to form a plurality of fashioned units;
performing a plastic injection process on the fashioned units to form a plastic layer on the ink pattern of each fashioned unit; and
forming a hardening layer over each fashioned unit to cover the surface, which is far away from the ink pattern.

2. The injection molding process of claim 1, wherein the step for forming the hardening layer includes performing a chemical vapor deposition (CVD) process or a physical vapor deposition (PVD) process.

3. The injection molding process of claim 2, wherein the physical vapor deposition (PVD) process includes an evaporation process, a sputtering process or an ion plating process.

4. The injection molding process of claim 1, wherein the material constituting the hardening layer includes transparent metallic oxide or transparent semiconductor oxide.

5. The injection molding process of claim 4, wherein the transparent metallic oxide comprises silicon oxide or aluminum oxide.

6. The injection molding process of claim 1, wherein the step for forming the hardening layer comprises:
dipping the fashioned units in a chemical solution; and
curing the fashioned units to form the hardening layer.

7. The injection molding process of claim 6, wherein the curing process is carried out using infrared light, ultraviolet light or heat from a baking oven.

8. The injection molding process of claim 6, wherein the main constituents of the chemical solution includes acrylates and its derivatives.

9. The injection molding process of claim 1, wherein the hardening layer has a pencil hardness ranging between 1 H to 7 H.

10. The injection molding process of claim 1, wherein the hardening layer has a thickness between about 10 nanometers and 1 micrometer.

11. The injection molding process of claim 1, wherein the material forming the plastic substrate is selected from a group consisting of polycarbonate (PC), polyethylene teraphthalate (PET), nylon, polymethyl methacrylate (PMMA) and acrylonitril butadiene styrene (ABS).

12. The injection molding process of claim 1, wherein the pre-forming process includes a punching process or a vacuum-forming process.

13. The injection molding process of claim 1, wherein the step for forming the ink pattern includes performing a screen printing operation.

14. The injection molding process of claim 1, wherein after trimming the plastic substrate, each fashioned unit comprises a plurality of protrusions and a planar portion between the protrusions.
